(19) United States
(12) Patent Application Publication
(10) Pub. No.: US 2008/0271478 A1
(43) Pub. Date: Nov. 6, 2008

(54) Cooling System and Method for Producing an Evaporation Plate for a Low Temperature Cooling System

(75) Inventors: Admilson Pinto, Aach (DE); Stephan Billen, Baustert (DE); Gunter Wagner, Leidenborn (DE)

Correspondence Address: PEARNE & GORDON LLP, 1801 EAST 9TH STREET, SUITE 1200, CLEVELAND, OH, 44114-3108, US

(73) Assignee: Dometic S.a.r.l., 9808 Hosingen (LU)

(21) Appl. No.: 11/568,688

(22) PCT Filed: May 13, 2005
(86) PCT No.: PCT/EP2005/005265

§ 371 Date: Jan. 15, 2007

(30) Foreign Application Priority Data
May 14, 2004 (DE) 20 2004 007 836.8

(51) Int. Cl. F25B 39/02; F25D 11/00; B23P 15/26

(52) U.S. Cl. 62/515; 62/440; 29/890.054

(57) ABSTRACT

The invention relates to a cooling system comprising an essentially flat evaporator consisting of individual evaporation plates (3a). Each evaporation plate comprises two high-grade steel plates (9 and 10) of different thicknesses, that are assembled by means of welding points (6) and welding seams (8). A channel (14) is formed between the high-grade steel plates (9 and 10), through which a coolant flows. Preferably, the evaporator forms part of the inner housing of a refrigerating appliance. The evaporator is produced by welding the plates (9 and 10) together. Compressed air is then blown between the plates (9 and 10), whereby the thinner of the two plates (9,10) is curved in such a way the channel (14) is created for the coolant.

The invention pertains to a cooling system including a heat insulating outside housing and a cooling unit with an evaporator of plane shape, as well as a method for manufacturing an evaporator plate for such a cooling system.

For cooling the inner chamber of traditional refrigerating units different cooling units are available. Essentially, the functional principle of a cooling unit is based on the utilization of physical effects and thermodynamic cycle processes. E.g. in a cold vapor process a slightly boiling liquid coolant is guided between two different pressures and relating boiling temperatures. The amount of thermal energy required for evaporation of the liquid coolant (evaporation heat) is extracted from the environment experiencing cooling down thereby. Thus, heat is absorbed from the cooling chamber by direct evaporation.

The cooling unit generally comprises an evaporator in which the boiling coolant is located. In traditional cooling systems, e.g. in compression refrigerators, the evaporator essentially is composed of serpentine-shaped channels or tubes arranged in a housing. In particular, the housings comprise an outer and an inner wall, between which the evaporator is arranged, regularly on the rearward side of the cooling chamber. Frequently, the evaporator is fixed with an insulation material, preferably curing foamed material, in its position between outside and inside housings.

It is, however, a disadvantage of these known systems that due to the arrangement of the evaporator channels in the insulation foam, heat transfer between evaporator and cooling chamber is hindered and thus the efficiency of the cooling output of the device is reduced, since cooling of the inner chamber of the cooling device is effected over two material borders. The cooling effect only occurs with temporal delay.

Alternatively, embodiments are known in which an evaporator with lines arranged in serpentines on a plate is used. The plate can be directly adjacent to the inner chamber of the cooling device. Thus, in traditional freezer sections and chest freezers (down to −30° C.) copper, aluminum or steel pipe serpentines are wound on aluminum and/or sheet steel. In low temperature region (with evaporation temperatures down to −100° C.) mainly inner containers made from sheet steel with wound copper pipe serpentine are made use of. This solution, however, is very expensive in construction. In addition, optimum energy transfer is not guaranteed. A further example for a known evaporator are pipe serpentines embedded in plastic material, by means of which the required efficiency cannot be achieved either. Homogenous distribution of cold can only be realized after longer period of time and with increased energy consumption. As a matter of fact a sinking temperature can be observed in direction of the admission opening.

In total it has to be stated that traditional evaporators due to their arrangement in the cooling chamber absorb heat from their environment only in a locally limited area. Homogenous temperature distribution in the cooling chamber as well as high cooling output can be achieved with difficulty and with high energy consumption only. The cooling effect as a rule occurs with temporal delay.

In particular in cooling systems designed for cryogenic regions, e.g. for a temperature range between −80° C. and −90° C., this causes problems in reaching and keeping these low temperatures with acceptable energy consumption.

A further problem occurs in compression refrigerators working at low temperature regions. The compressor oil obligatorily in certain amounts enters the coolant and thus the evaporator. Due to the very low temperatures the oil can settle in the evaporator. Thereby, the heat transfer efficiency thereof, of the evaporator sinks. In worst case the evaporator with time passing will become completely useless for the given temperature range.

On basis thereof, the object of the present invention lies in making available a cooling system with high efficiency of heat and/or cooling transfer and high coefficient of performance, wherein homogenous temperature distribution in the cooling chamber can be guaranteed. In particular, the cooling system is to be permanently usable in cryogenic temperature regions, in the region between −80° C. and −90° C. in particular.

A further object of the invention lies in proposing a simple, cheap manufacturing process for manufacture of an efficient evaporator for the cooling system.

These objects are solved by a cooling system in accordance with claim 1 and a manufacturing process in accordance with claim 20.

The cooling system in accordance with the present invention includes a heat insulating outside housing and a cooling unit with an evaporator comprising at least one evaporator plate of plane shape, including at least two plates of such shape and joining that a channel for a coolant is formed between said plates.

The channel formed between the plate surfaces is passed by the coolant in large area. In this way an homogenous temperature distribution over the plate surface and thus an homogenous cooling of the inner chamber of the cooling device is achieved. The channels are formed such that the pressure drop or the pressure difference in the evaporator is minimized. In addition to the simple construction, high temperature homogeneity and stability and thus a high efficiency of the cooling system is reached. Therefore, the cooling system is suitable for the generation of very low temperatures in particular, also in the range of less than −80° C.

Preferably, the plates are mutually connected by welding.

The plates are mutually connected by welding seams and/or welding points in particular. In a marginal area of the plates a circumferential welding seam is formed so that the channel is limited to the plate surface and is bordered to the outside. Further welding lines are arranged such that a channel guidance is made available which acts against the problems of pressure drop in the evaporator as well as of incomplete return of compressor oil. Additional welding points improve distribution of the coolant over the plate surface within the channel so that a large and homogenous evaporation surface with excellent heat transfer between the inner chamber of the cooling device and the evaporator is created. Instead of the welding points also weldings of other shaped, e.g. circular welding seams, can be provided for. These weldings give additional mechanical stability to the evaporator.

The welding seams preferably are arranged such that the channel formed between the plates, for the coolant extends essentially in serpentines or in meanders.

The welding seams limiting the channel can be arranged or inclined such that the coolant can exit without reflux under the influence of gravity. In this way the compressor oil taken with the coolant is returned. For this purpose in the plates laterally arranged in the inner chamber of the cooling device (i.e. vertically), the channel separations can be inclined in downward direction in direction of passage of the coolant so that oil return as complete as possible is given.

The evaporator plate in particular comprises at least one inlet for the coolant and at least one outlet for the coolant. A plate arranged on the top side of the inside chamber of the cooling device, forming the cover part of the inside housing, in particular comprises one single inlet for the coolant. The coolant e.g. is injected in one single position in the middle of the upper plate. The coolant flow is divided into two in the upper plate for supplying two plates laterally arranged in the inside chamber of the cooling device and aligned vertically. The high mass flow of coolant in the upper plate causes an efficient transfer of the taken compressor oil.

At least one of the plates of the evaporator plate preferably is made from special steel, stainless steel in particular.

As a rule the two joined plates of the evaporator plate are made from special steel, stainless steel in particular. This material is suitable for an evaporator because of its stability. Since the coolant is a high pressure coolant, forces can occur which, however, can be born by special steel without problem. A further advantage of the use of special steel plates lies in the high thermal stability due to the high thermal capacity of the material. This, again, causes high temperature homogeneity and reduction of energy consumption.

The plates can be of different thicknesses.

The cooling system in particular comprises an inside housing for forming an inner chamber for storing goods requiring cooling. The inside housing at least partly is formed by the plane evaporator.

The evaporator forming the inside housing in detail is formed of at least one, preferably several, in particular three evaporator plates. These thus are in direct contact with the inside chamber of the cooling system. Preferably, the plates are arranged in U-shape along the left-hand, upper and right-hand inner surface of the inner chamber to be cooled for guaranteeing the desired homogenous cooling effect. However, it also is conceivable to provide for plates—depending on the desired use—also on the bottom or on the rear wall of the inner chamber.

The individual evaporator plates therein comprise a continuous evaporator channel in which the coolant producing the cooling effect during evaporation is guided. For making available a surface as large as possible, the channel can be formed in serpentines. In particular, the embodiment of the inside wall of the housing shows a positive effect due to the evaporator or the evaporator channels themselves, since due to this embodiment of the cooling system the transfer of cold from the evaporator or the evaporator channels to the inner chamber is realized directly, i.e. saving the material border evaporator—insulating foam, having negative influence of the energy flow. An increase in efficiency of the devices as well as a reduction in energy consumption are the direct consequence, since during operation heat absorption, i.e. cooling of the inner chamber has to take place via one material border only. By using plates of special steel, for the evaporator the energy consumption can be reduced as well, since the plates in regular operation heat up only slowly because of their high thermal capacity. This permits long compressor holding times causing lower energy consumption. An additional advantageous point is the embodiment of the inside wall of the cooling housing as evaporator itself in view of the background of a homogenous temperature distribution in the housing interior, as radiation of cold is achieved from several sides.

The gap between outside and inside housing can be filled with a thermally insulating material, e.g. insulation foam. Thereby, the required thermal insulation with respect to the system border of the cooling system is maintained. Simultaneously, the insulting foam introduced in liquid form and curing later on acts as spacer between the outside housing and the evaporator. A certain adhesive function with respect to the inner housing located inside, as well, is conceivable so that further fixation means can be done without. The loss in cold or energy during operation, thus, is reduced efficiently.

The areas with a spacing between the plates of the evaporator plates are formed between the welding seams and/or welding points, in particular. By suitable arrangement of the welding seams and points an optimum cross-section over the entire length as well as suitable stability can be allotted to the channel.

At least one of the plates preferably is deformed plastically such that areas are formed with a gap between the plates, forming the channel. By the spot weldings, the cross-section of the channel can be fixed over its entire length for achieving optimum passage conditions for the coolant. The at least one plate arranged in erection of the cooling system preferably directed to the inside chamber of the cooling device, due to the deformation has an enlarged area through which heat exchange between the cooling chamber and the coolant can take place. Thus, efficiency of the cooling system is increased.

The evaporator in particular comprises at least two evaporator plates which at least partly form the lateral regions of the inside housing. This results in a good temperature distribution in the cooling chamber without the requirement of forced air circulation.

In a particularly preferred embodiment, the evaporator comprises at least one further evaporator plate which at least partly forms the cover area of the inside housing. When using several evaporator plates, those can be embodied such that the coolant simultaneously is introduced into the evaporator plates for producing uniform cooling effect. Therein, the at least one evaporator plate comprises at least one inlet and at least one outlet, through which the coolant to be evaporated can on one hand be supplied and the coolant already evaporated and after phase transfer being present in gaseous condition can be removed. However, it also is conceivable that in spite of the modular, flexibly usably embodiment of the individual evaporator plates the respectively provided evaporator channels on the individual plates can be mutually connected such that they either form a continuous channel so that the vapor can flow through all plates without hindrance and the entire evaporator is available as effective area for heat absorption or for cold emission.

At least one of the lateral evaporator plates can comprise welding seams such that the coolant can flow without reflux from an inlet arranged in the upper region of the evaporator plate to an outlet arranged in the lower region of the evaporator plate. In compressor refrigerating systems it cannot be avoided that oil used in the compressors mixes with the coolant and together therewith is transferred into the evaporator. In particular in case of very low temperatures, return of the oil is a problem. Since the oil at the low evaporator temperatures down to −100° C. is not completely mixable with the coolant, the oil tends to settling on the cold areas in the evaporator. An oil layer in the evaporator, however, reduces heat transfer and the output of the device. The particular embodiment of the invention contributes to the solution of the problem, as with an exit of the coolant without reflux also the oil is continually removed from the evaporator.

The inside housing on the inner surfaces, on the side walls in particular, can comprise storage means into which deposit elements for depositing goods requiring cooling can be inserted. Thus, the offer in space available, of the inner chamber can be adapted to the requirements or the goods requiring cooling, respectively.

The cooling system preferably includes a heat exchanger fixed to the outside housing as modular member separately from the outside housing and being connected to the evaporator. As heat exchanger, e.g. a double-pipe heat exchanger can be used. Whereas up to now, however, heat exchangers were integrated into the container and are co-foamed within it, the heat exchanger in accordance with the present invention is not an integral part of the housing of the cooling system but at first is manufactured as separate part. The part foamed-in separately can e.g. be mounted in a compressor compartment on the housing. The connection to the evaporator is created by corresponding terminals.

The object of the invention is also solved by a method for manufacturing an evaporator plate for a cryogenic cooling system as described above, characterized by the following steps:
making available at least two plates;
aligning the plate surfaces mutually;
connecting the plates by welding together the plates; and
forming a channel between the plates by introducing air between said plates.

The manufacturing method is particularly suitable also in case of use of special steel plates. It is simple and favorable in costs.

The plates are mutually connected by line and/or spot welding in particular. Spot welding can e.g. be effected using a laser.

The air preferably is blown in between the plates as compressed air with a pressure of about 150 bar in particular, for at least plastically deforming at least one of the plates for forming the channel for the coolant.

The plates preferably are made from stainless special steel.

The plate can have different thicknesses. When introducing the compressed air in this case the thinner plate is deformed to a much higher degree than the thicker one. In an approximation only the thinner plate is deformed. It has a correspondingly larger surface which can be used for an efficient heat exchange. The side facing the outside housing, however, is essentially flat. Based on different considerations, e.g. for reasons of surface condition of the inside wall of the cooling device, however, the deformed side of the plate can also be directed to the outside wall of the housing. Possible thickness values for the special steel plates can be given as examples with 1 mm or 2.5 mm.

By the introduction of air at least one of the plates is plastically deformed such that areas are formed with a gap between the plates, forming the channel.

The areas with a gap between the plates are formed between the welding seams and/or welding points in particular. The thinner one of the two plates is plastically deformed during being charged with compressed air in the areas between the welding points or seams. A desired channel diagram with given diameters is created by the vaultings.

Further features and advantages of the invention can be seen from the following description of preferred embodiments as well as from the attached drawings. In the drawing:

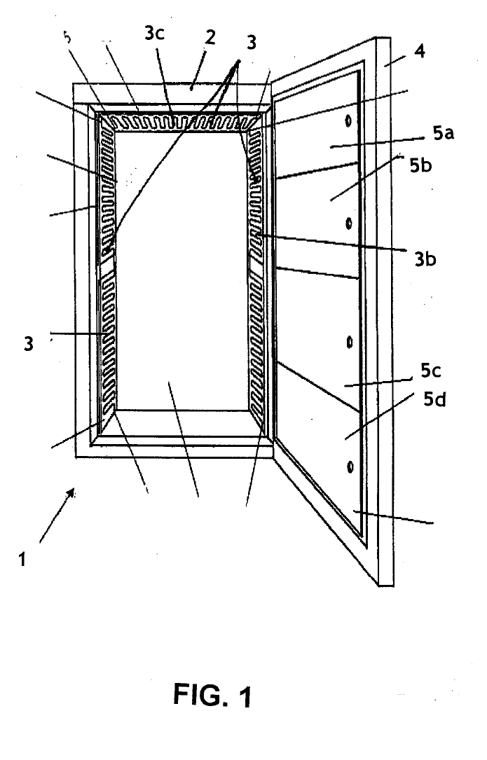

FIG. 1 is a front view of the cooling system in accordance with the present invention;

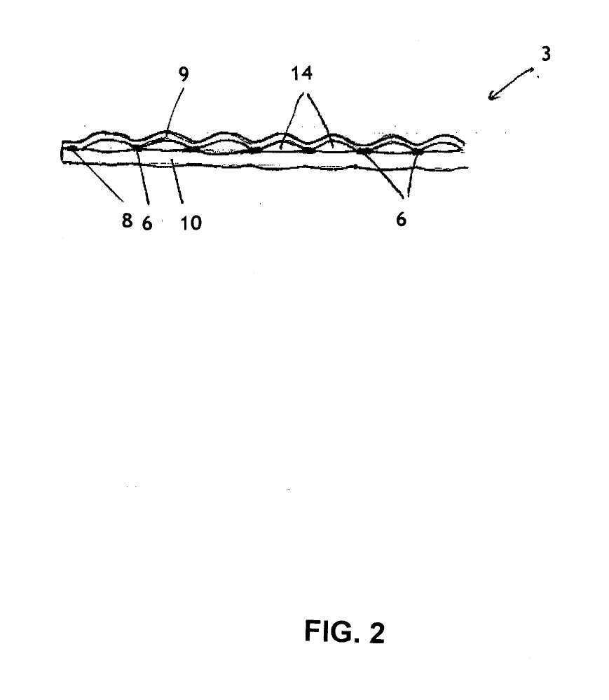

FIG. 2 is a sectional view of a section of an evaporator plate in accordance with the present invention;

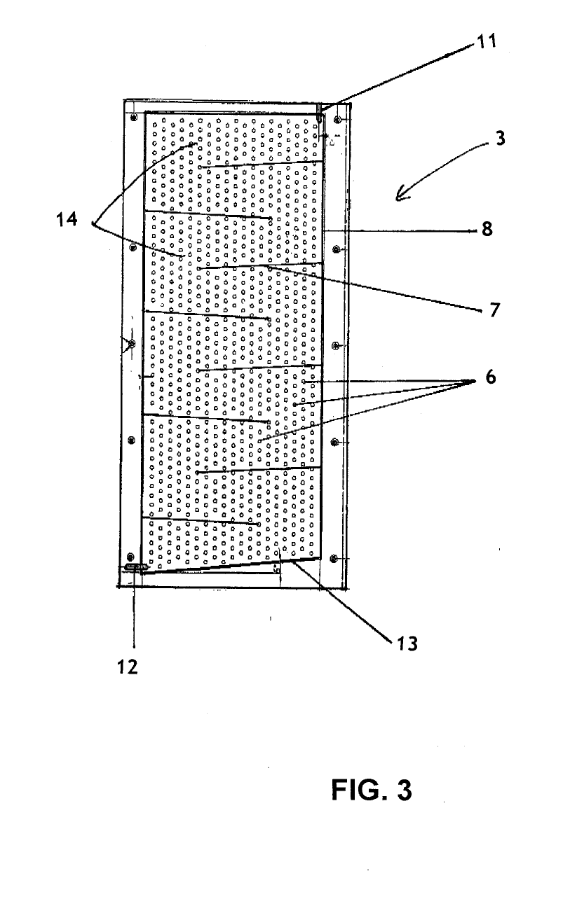

FIG. 3 is a top view onto an evaporator plate for lateral arrangement in the cooling device in accordance with the present invention; and

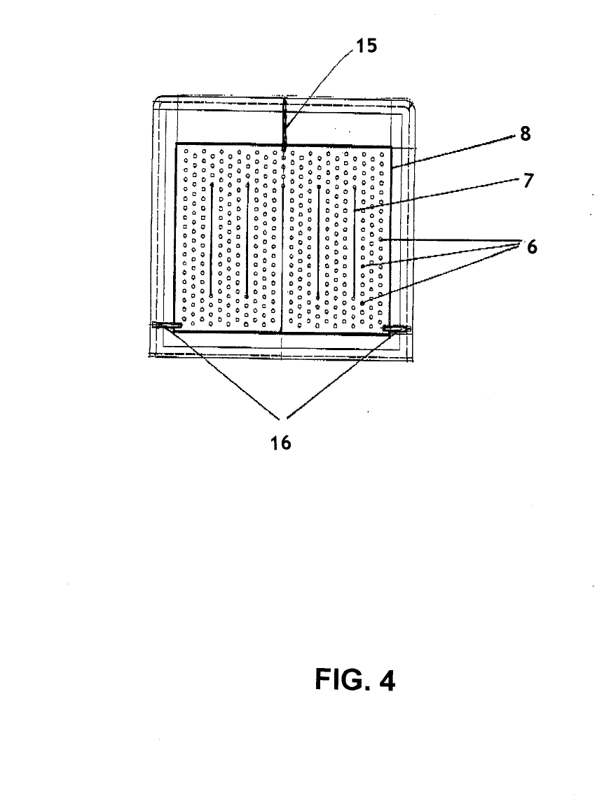

FIG. 4 is an evaporator plate in accordance with the present invention, intended for use in the cover range of a cooling device.

In FIG. 1 a cooling device 1 is shown comprising an outside housing 2 and an inside housing. The inside housing is at least partly formed by an evaporator 3 which again is essentially composed of evaporator plates 3a, 3b and 3c. Said evaporator plates 3a and 3b each from side walls of said inside housing, evaporator plate 3c forms the cover region of said inside housing. Said plates, however, can also cover other inside chamber regions. Said evaporator plates 3a, 3b and 3c are in direct contact with the inside chamber of said cooling device 1. In this way, high efficiency in the cooling output and thus a reduction of the energy consumption is achieved, since cooling of the inside chamber is effected over one material border only.

The gap between said inside housing and/or evaporator 3 and said outside housing 2 can e.g. be filled with a heat insulating material, an insulating plastic foam in particular. Thereby, cold insulation between the inside chamber formed by the inside housing, of said cooling device 1 and said outside housing 2 is reached. Simultaneously, the insulating plastic foam, introduced in liquid form and cured lateron, can act as spacer between said housing parts 2 and 3.

The invention, however, is not to be restricted to this kind of fixation. Said evaporator 3 forming said inside housing can e.g. be fixed to an intermediate additionally wall inserted between outside and inside housing, by means of holding means. The gap formed between the outside wall and the intermediate wall in correspondence with the above embodiment is foamed with said insulating plastic foam. Said evaporator plate as well as the embodiment and the mutual arrangement of the plates therein corresponds to the above description.

The inner chamber of said cooling device 1 is admissible through an inlet opening preferably arranged on the front side of said cooling device 1. Said outside housing 2 comprises an heat insulated outside door 4. The inside door 5 is formed in segments and is heat insulated as well. It consists of several flap-shaped segments 5a, 5b, 5c and 5d which can be operated independently from said outside door 4. Said segments 5a, 5b, 5c and 5d in addition can be opened and closed independently from one another. Thereby, aimed access into the inner chamber of said cooling device 1 is permitted without negative effect on the cooling effect in the areas not opened.

Said outside door 4 similar to said cooling device housing preferably is embodied double-walled so that a gap is formed between outside and inside housings of said door, which gap like the gap between outside housing 2 and inside housing can be foamed with insulating foam.

Said cooling device 1 in addition comprises a cooling unit including a condenser and an heat exchanger (both not shown) in addition to said evaporator 3. Said heat exchanger can e.g. be a double-pipe heat exchanger. Said cooling unit can consist of a cascade system with two separate compressor cycles. On the high temperature side e.g. the coolant R404A is used, which becomes liquid at a condenser at room temperature, and in the cascade heat exchanger the coolant e.g. R508B cooling low temperature side is used. The coolant R508B becomes liquid in the cascade heat exchanger and thereafter is injected in the evaporator plates.

In a preferred embodiment which, however, is not shown in the drawing, said inside housing 3 in addition on the inner surfaces, on the side walls in particular, comprises suitable storage means into which correspondingly shaped deposit elements or deposit trays can be inserted for correspondingly adapting the offered space of said inside chamber 4 to the requirements or the objects requiring cooling. An adaptation in size of the number of deposit elements to the above-described inside door subdivided into a plurality of segments 5a-5d is conceivable.

FIG. 2 schematically shows one of said evaporator plates 3a, 3b, 3c in cross-sectional view. Said plate 3a essentially consists of two stainless steel plates 9 and 10 of different thicknesses. E.g. plate 10 has a thickness of 2.5 mm, plate 9 has a thickness of 1 mm.

During the manufacturing process plates 9 and 10 are positioned one on top of the other and are adjusted. The outside regions of said plates 9 and 10 one lying adjacent to the other, at least sectionally are connected by means of a sealing welding seam 8 (welding line). Moreover, for connecting said two plates 9 and 10 welding points 6 are formed in given spacing using spot welding.

The thinner of said two steel plates 9 in the following is slightly vaulted by introduction of compressed air, e.g. with a pressure of 150 bar, between said welding seams 6 or said welding points 8 so that a channel 14 for passage of a coolant is formed between said plates 9 and 10. Said welding seam 8 forms a bordering of said channel 14 in lateral marginal area of said plates 9 and 10. As will be described later, additional welding seams or lines can be provided for, in order to define a channel for the coolant, extending from an inlet to an outlet.

Said welding points 6 are arranged such that a desired vault of said thin steel plate 9 is achieved. Thereby, defined passage channels 14 are created. In addition, the structure of said evaporator 3 is stabilized. The surface of said vaulted thinner plate 9 can be directed to the inside in the arrangement of said evaporator plates 3a, 3b and 3c in said cooling device, since said enlarged surface of said plate 9 is particularly suitable for transfer of evaporation heat from said cooling chamber to said coolant. If required, the deformed surface, however, can also be directed to said outside housing 2.

FIG. 3 shows one of said laterally arranged evaporator plates 3a, 3b in top view. Two steel plates lying one on top of the other in the plane of the sheet are mutually connected by a welding seam 9 over almost the entire circumferential area. In addition, said evaporator plate 3a comprises welding points 6 as additional connection between the plates one lying on top of the other. Between said welding points 6 and welding lines 8 a channel 14 extends which is formed by vaulting of at least one of the plates one lying on top of the other for passage of the coolant, from an inlet 11 to an outlet 12, passing through said evaporator plate 3a.

Further welding lines or welding seams 7 extend from the marginal region to the inside, for effecting passage of said coolant through said evaporator plate 3a, in possibly essentially serpentine-like or meander-like passage. The coolant is supplied from top through an inlet 11 and flows through said channel 14 in direction of an outlet 12 in the lower region of said evaporator plate 3a. By said welding points 6 and said welding lines 7 said coolant is distributed over almost the entire surface of said plate when passing through said evaporator plate 3a. In this way, an homogenous temperature over almost the entire surface and thus high efficiency in cold transfer is achieved.

Extending from the lateral margin of said plates, said welding lines 7 are slightly inclined in downward direction in direction to the center (and extending it) for avoiding reflux of said coolant during passage. The lower bordering 13 of said channel 14 and the relating welding seam also are inclined in direction to said outlet 12 for guaranteeing reliable exit of said coolant.

These measurements are particularly important as in this way the taken oil from the compressor of said cooling device does not flow back but is removed. An oil layer in said evaporator would reduce heat transfer and the output of the device.

Moreover, for solving this problem in addition to the coolant intended for operation of said cooling system an additional coolant for increasing mixability of said coolant with oil can be admixed. Synthetic oils (e.g. polyolester oil) e.g. only are compatible with synthetic coolants. In the present case ethane is used as additional coolant. Ethane can be added to the coolant R508B at a given ratio (approximately up to about 5.6 percent) with the mixture becoming combustible. The mixture ethane/R508B in addition has a better efficiency than pure R508B. By adding ethane anyway the mixability of the oil with the coolant is guaranteed and oil return from the evaporator to the compressor is improved.

In FIG. 4 a cover-side evaporator plate 3c is shown in top view. It also consists of two special steel plates fixed one on top of the other with respect to the plate plane, at least one of them being vaulted so than channels for passage of a coolant are created between the connection points or lines. Said coolant is supplied to said evaporator plate 3c through a central supply line 15. In the marginal area of the plates arranged one on top of the other said special steel plates are mutually connected by a welding seam 8. By said line-shaped welding connections 7 and said welding points 6 connecting said steel plates the passing coolant is distributed over a large surface area of said plate 3c as uniformly as possible.

The coolant is supplied into the lateral areas of said evaporator 3 through two outlets 16 connected by inlets 11 (see FIG. 2) to said lateral evaporator plates 3a and 3b. Said laterally arranged evaporator plates 3a and 3b, thus, are supplied with said coolant via said cover-side evaporator plate 3c through one inlet each.

Having passed through said lateral plates 3a, 3b said coolant exits and is supplied to a double-pipe heat exchanger. When entering said heat exchanger, said coolant still has a quite low temperature, e.g. −90° C. In said heat exchanger said coolant is heated and then fed to said compressor.

Said evaporator plates 3a, 3b and 3c each comprise a channel 14 in practice extending over the entire surface. In this way a surface as large as possible and in terms of temperature distribution comparatively homogenous is made available, through which cooling of said inner chamber of said cooling device 1 is effected.

For operation of said cooling system known suitable coolants can be used. In particular, in the scope of this invention coolants are to be used having evaporation temperatures down to −100° C.

1. Cooling system (1) including a heat insulating outside housing (2) and a cooling unit with an evaporator (3), characterized in that said evaporator (3) comprises at least one evaporator plate (3a, 3b, 3c) of plane shape, which includes at least two plates (9, 10) of such shape and being mutually connected such that between said plates (9, 10) a channel (14) for a coolant is formed.

2. Cooling system (1) as defined in claim 1, characterized in that said plates (9, 10) are mutually connected by welding.

3. Cooling system (1) as defined in one of the preceding claims, characterized in that said plates (9, 10) are mutually connected by welding seams (7, 8) and/or welding points.

4. Cooling system (1) as defined in claim 3, characterized in that said welding seams (7, 8) are arranged such that said channel (14) formed between said plates (9, 10) for said coolant essentially extends in serpentines or meanders.

5. Cooling system (1) as defined in claim 4, characterized in that said welding seams (7) bordering said channel (14) are arranged and/or inclined such that said coolant can exit without reflux under the influence of gravity.

6. Cooling system (1) as defined in one of the preceding claims, characterized in that said evaporator plate (3a, 3b, 3c) comprises at least one inlet (11) for said coolant and at least one outlet (12) for said coolant.

7. Cooling system (1) as defined in one of claims 6 or 7, characterized in that at least one of said plates (9, 10) of said evaporator plate (3a, 3b, 3c) is made from special steel, stainless steel in particular.

8. Cooling system (1) as defined in one of the preceding claims, characterized in that said two connected plates (9, 10) of said evaporator plate (3a, 3b, 3c) are manufactured from special steel, stainless steel in particular.

9. Cooling system (1) as defined in one of the preceding claims, characterized in that at least one of said plates (9) is plastically deformed such that areas with a gap between said plates (9, 10) are formed, which form said channel (14).

10. Cooling system (1) as defined in claim 9, characterized in that said areas with a gap between said plates (9, 10) are formed between said welding seams and/or welding points.

11. Cooling system (1) as defined in one of the preceding claims, characterized in that said plates (9, 10) are of different thicknesses.

12. Cooling system (1) as defined in one of the preceding claims, characterized in that said cooling system (1) comprises an inside housing for forming an inner chamber for storing goods requiring cooling and said inside housing at least partly is formed by said plane evaporator (3).

13. Cooling system (1) as defined in claim 12, characterized in that said evaporator (3) comprises at least two evaporator plates (3a, 3b) at least partly forming the lateral areas of said inside housing.

14. Cooling system (1) as defined in claim 13, characterized in that said evaporator (3) comprises at least one further evaporator plate (3c) at least partly forming the cover-side area of said inside housing.

15. Cooling system (1) as defined in one of claims 13 or 14, characterized in that at least one of said lateral evaporator plates (3a, 3b) comprises welding seams (7, 13) such that said coolant can exit without reflux from an inlet (11) arranged in the top area of said evaporator plate (3a, 3b) to an outlet (12) arranged in the lower area of said evaporator plate (3a, 3b).

16. Cooling system (1) as defined in one of the claims 13 to 15, characterized in that said inside housing comprises storage means on said inside surfaces, on the side walls in particular, into which deposit means for depositing goods requiring cooling can be inserted.

17. Cooling system (1) as defined in one of the preceding claims, characterized in that an additional coolant for increasing mixability of said coolant with oil is admixed to said coolant intended for operating said cooling system (1).

18. Cooling system (1) as defined in claim 17, characterized in that said admixed coolant includes ethane.

19. Cooling system (1) as defined in one of the preceding claims, characterized in that said cooling system (1) includes an heat exchanger fixed to said outside housing as module separated from said outside housing (2), and being connected to said evaporator (3).

20. Method for manufacturing an evaporator plate (3a, 3b, 3c) for a cooling system (1) as defined in one of the preceding claims 1 to 19, characterized by the following steps:
providing at least two plates (9, 10);
aligning said plate surface with respect to one another;
connecting said plates (9, 10) by welding said plates together; and
forming a channel (14) between said plates by inserting air between said plates.

21. Method as defined in claim 20, characterized in that said plates (9, 10) are mutually connected by line and/or spot welding.

22. Method as defined in one of the claims 20 or 21, characterized in that said air is blown in between said plates (9, 10) as compressed air, with a pressure of about 150 bar in particular, for plastically deforming at least one of said plates (9) for forming a channel (14) for said coolant.

23. Method as defined in one of the claims 20 to 22, characterized in that said plates (9, 10) are manufactured from stainless steel.

24. Method as defined in one of the claims 20 to 23, characterized in that said plates (9, 10) have different thicknesses.

25. Method as defined in one of the claims 20 to 24, characterized in that by introducing air at least one of said plates (9) is plastically deformed such that areas with a gap between said plates (9, 10) are formed, which form said channel (14).

26. Cooling system (1) as defined in claim 25, characterized in that said areas with a gap between said plates (9, 10) are formed between said welding seams and/or welding points.
